(19) United States
(12) Patent Application Publication
(10) Pub. No.: US 2010/0071798 A1
(43) Pub. Date: Mar. 25, 2010

(54) MONOLITHIC CERAMIC LINED FIBER GLASS PIPING AND FITTINGS

(76) Inventors: Dino L. Tsapatsaris, Wykoff, NJ (US); Sean Matthew, Lyndhurst, NJ (US)

Correspondence Address: Mr. Walter J. Tencza Jr.,, Suite 210, 100 Menlo Park, Edison, NJ, 08837, US

(21) Appl. No.: 12/236,593

(22) Filed: Sep. 24, 2008

(51) Int. Cl. F16L 9/14; B32B 1/08; B32B 17/04

(52) U.S. Cl. 138/144; 53/396; 138/141

(57) ABSTRACT

A method is provided involving manufacturing a solid monolithic hollow ceramic liner, such as a cylinder, reducing cone and bend and then wrapping the solid monolithic hollow ceramic liner with a fiber glass resin. This forms an external housing for the mold and flange connections can be fixed on either end to facilitate its connection to valves, pumps and other piping systems.

### FIELD OF THE INVENTION

This invention relates to improved methods and apparatus concerning abrasion and corrosion resistant linings for use in process piping.

### BACKGROUND OF THE INVENTION

In the prior art, abrasion and corrosion resistant linings may be made of glass, rubber, basalt, hard facings, coatings, trowelable linings, cure-in-place linings, and plastics that are commonly used to extend the life of piping systems.

In addition, abrasion resistant linings and/or fittings with the use of ceramics has been around for many years and has been used extensively in the power and chemical industries. For example, ceramics, such as alumina and silicon carbide ceramics, are currently being used as liners in carbon steel shells. These ceramics, are also used for elbows, reducers, tees and piping for slurry applications like lime slurry, gypsum, fly ash, etc.

With the introduction of a corrosive into a process stream (such as slurry with abrasive solids), most linings and/or fittings become incompatible and their use is extremely limited.

In the prior art woven mats and vinyl resins were wrapped on a wooden mold which was later removed after an outer part has been formed and cured. An inner part, such as a ceramic tube, was then inserted into the outer part (such as a cured woven mat and/or vinyl resin formed by use of the wooden mold.

### SUMMARY OF THE INVENTION

In at least one embodiment of the present invention, a ceramic inner tube or cylinder is provided, and is wrapped by a fiber glass outer covering.

In at least one embodiment of the present invention an apparatus is provided including a solid monolithic hollow ceramic inner liner, and a fiber glass outer covering which has been wrapped around the solid monolithic hollow ceramic inner liner. The solid monolithic hollow ceramic inner liner may be an inner tube, a reducing cone, an elbow, and/or cylinder. The solid monolithic hollow ceramic inner liner may be made of alumina ceramic, silicon carbide, or reaction bonded silicon carbide. The fiber glass outer covering may be made of a vinyl ester or a glass fiber mat.

In at least one embodiment of the present invention a method is provided which includes forming a solid monolithic hollow ceramic inner liner; and rapping a fiber glass outer covering around the hollow ceramic inner liner. A hand lay-up process may be used to wrap the fiber glass outer covering. The method may further include passing a liquid through the solid monolithic hollow ceramic inner liner. The liquid may be a slurry.

The present invention in one or more embodiments, provides a method and/or apparatus in which a ceramic part is designed and fabricated to form a reducing cone or a cylinder and a fiber glass hand lay up process is carried out using the ceramic part as a mold. In at least one embodiment of the present invention the finished apparatus includes a solid ceramic inner piece, such as a tube, elbow or reducer cone, and an outer fiber glass covering.

In at least one embodiment of the present invention, three solid types of ceramic, such as cones, elbows, and cylinders may be used as liners in a fiber glass shell or fiber glass outer covering.

A ceramic liner together with the fiber glass outer covering or shell formed in accordance with an embodiment of the present invention approaches a diamond in hardness, is chemically inert to almost all corrosives, and can be used in high chloride processes safely.

In one embodiment of the present invention a method is provided including laying-up of or wrapping of fiber glass around a ceramic core. Vinyl ester & glass fiber mats may be wrapped around a ceramic core with flanges fixed on each end to form a straight pipe, elbow, reducer or tee.

The size of ceramic lined fiber glass fittings in accordance with an embodiment of the present invention may range from one inch through twenty-inches. They are the next generation abrasion resistant fittings which are particularly useful in slurry applications in a high chloride environment.

### BRIEF DESCRIPTION OF THE DRAWINGS

FIG. 1 shows a top perspective view of an apparatus in accordance with an embodiment of the present invention;

FIG. 2 shows a bottom perspective view of the apparatus of FIG. 1;

FIG. 3 shows a top view of the apparatus of FIG. 1;

FIG. 4 shows a side view of the apparatus of FIG. 1;

FIG. 5 shows a cross sectional view of the apparatus of FIG. 1; and

FIG. 6 shows a flow chart of a method in accordance with an embodiment of the present invention.

### DETAILED DESCRIPTION OF THE DRAWINGS

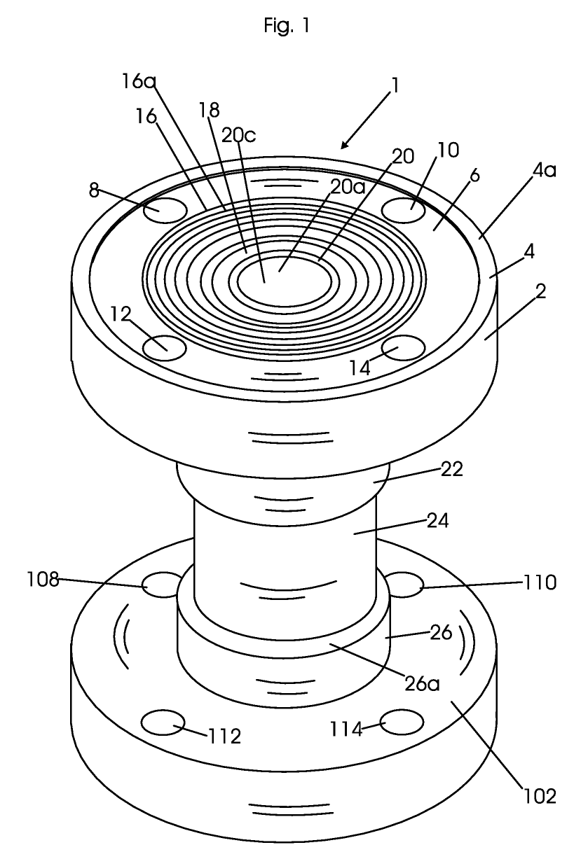

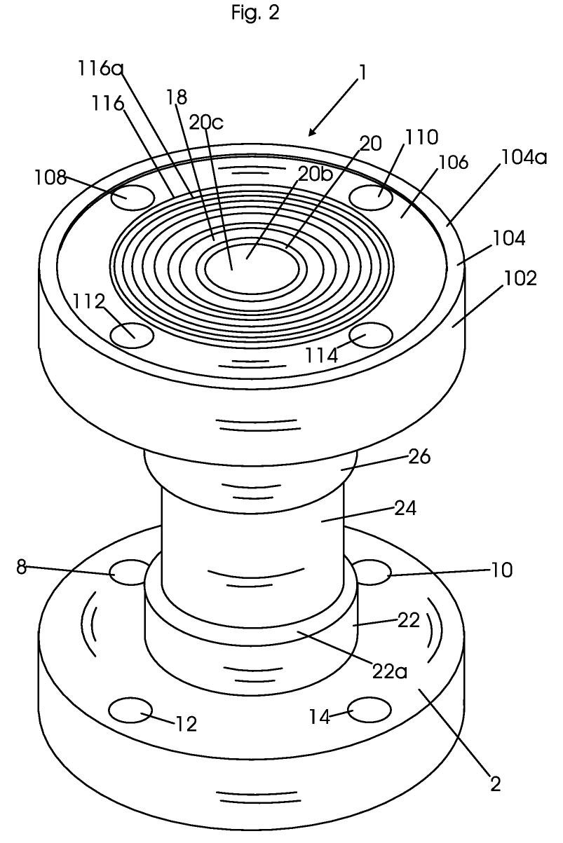

FIG. 1 shows a top perspective view of an apparatus 1 in accordance with an embodiment of the present invention. FIGS. 2-5 show bottom perspective, top, side, and cross sectional views of the apparatus 1 of FIG. 1. The apparatus 1 is comprised of flange section 2, stub sections 22 and 26, central or pipe section 24, and ring or flange section 102.

As shown in FIG. 1, the top, ring, or flange section 2 is comprised of outer peripheral flange 4 and inner region 6. The outer peripheral flange 4 has a top surface 4a. The inner region 6 has cylindrical openings or bores 8, 10, 12, and 14, which run through the inner region 6. The inner region 6 also has a plurality of concentric ridges 16, including ridge 16a. A cylinder or liner 18 may be made of an epoxy binder and surrounds an inner ceramic cylinder 20. The outer cylinder 18 and the inner cylinder 20 run through the section 2, section 22, pipe section 24, section 26, and section 102. The inner ceramic cylinder 20 has an opening 20a leading to a cylindrical bore or inner chamber 20c, which runs the length of the apparatus 1 through sections 2, 22, 24, 26, and 102, out to opening 20b shown in FIG. 2 from the section 102.

As shown in FIG. 2, the bottom, ring or flange section 102 is comprised of outer peripheral flange 104 and inner region 106. The outer peripheral flange 104 has a bottom surface 104a. The inner region 106 has cylindrical openings or bores 108, 110, 112, and 114, which run through the inner region 106. The inner region 106 also has a plurality of concentric ridges 116, including ridge 116a. One end of the epoxy 18 which surrounds the plastic or ceramic inner pipe or cylinder 20 is shown in FIG. 2.

The openings or bores 8, 10, 12, and 14 are aligned with the openings or bores 108, 110, 112, and 114, so that the apparatus 1 can be connected to similar or identical apparatus or some other type of piping or fitting in a piping system or a valve in a piping system. For example flange 102 of apparatus 1 may be connected to a flange 2′ identical or similar to flange 2 of an apparatus 1′, similar or identical to apparatus 1. Openings or bores 108, 110, 112, and 114 of apparatus 1 would be lined up with bores 8′, 10′, 12′, and 14′ of apparatus 1′ which may be identical to apparatus 1. The openings or bores 8, 10, 12, 14, 108, 110, 112, and 114 may be bolt holes and their size may depend on the size of section or flange 2 and/or 102.

The apparatus 1 may be a ceramic lined fiber glass spool. The pipe 24 may be a fiber glass cylindrical pipe, tube, or piping. The outer cylinder 18 may be made of an epoxy binder. The outer cylinder 18 may not be needed in some cases. The inner cylinder 20 may be made of alumina ceramic. The inner cylinder 20 may also be made of Silicon Carbide (SiC) or reaction bonded silicon carbide.

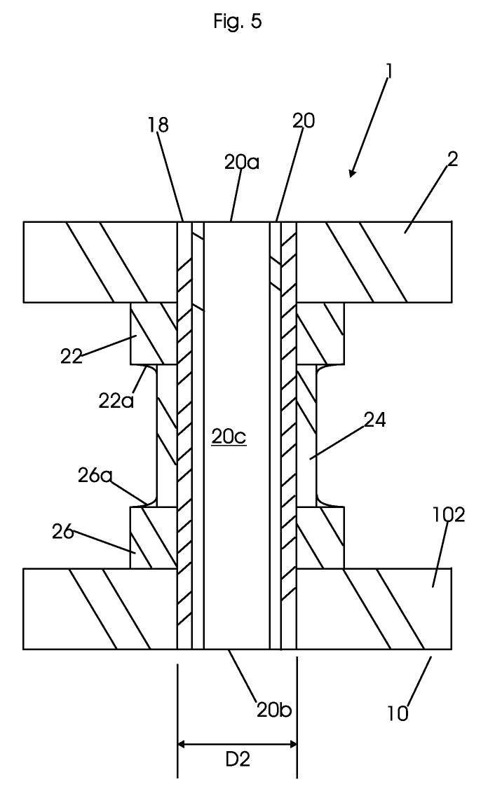

As shown in the cross sectional view of FIG. 5, rings or sections 2 and 102 (not including cylinders 18 and 20) may be fiberglass housing. The sections 22, 24, and 26 (not including cylinders 18 and 20) may also be fiberglass housing. The cylinder 18 may be an epoxy binder. The epoxy binder cylinder 18 is not always required because the fiber glass section 2, 22, 24, 26, and 102 shown in FIG. 5 act as a binder to hold the ceramic cylinder 20. The cylinder 20, i.e. the innermost cylinder, may be a ceramic tube. The cylinder 20 may be made, for example, of one of the following: alumina, silicon carbide (SiC), or reaction bonded silicon carbide (SiC).

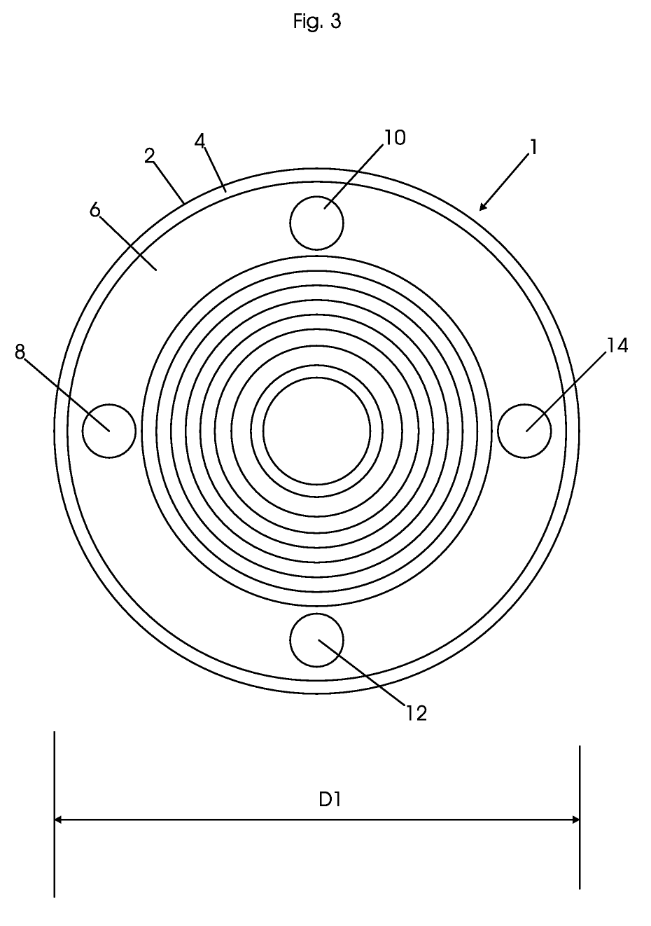

The diameter D1 shown in FIG. 3 may be from four and one quarter inches to twenty-seven and one half inches.

The central pipe or piping 24 is wrapped around cylinders 18 and 20.

The sections 22 and 26 may be stub ends of flanges or sections 2 and 102, respectively. The stub ends or sections 22 and 26, in one embodiment, are machined and joined to the fiber glass pipe or piping 24 with the help of glass fibers & resins.

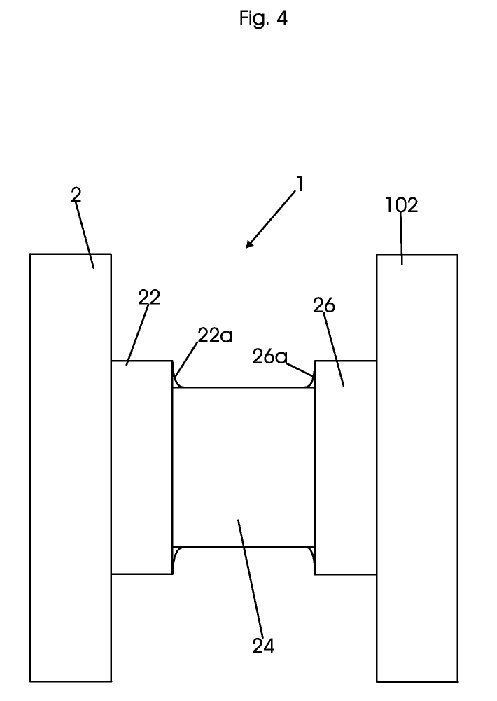

As shown in FIG. 4, the rings or stub ends 22 and 26 may be joined to the pipe 24 at curved junctions 22a and 26a. The curved junctions 22a and 26a are curves which are standard during the joining process of a stub end of a flange to a pipe with glass mats and resins.

The apparatus 1, shown in FIGS. 1-5, may be a fiber glass straight spool, which can be fabricated in sizes ranging from one inch in diameter to twenty inches in diameter for the dimension D1 shown in FIG. 3.

Alternative apparatuses or fittings can be formed in different shapes or configurations other than the spool configuration shown in FIGS. 1-5. For example the apparatus 1 may be replaced by a ninety and/or forty-five degree elbow with a short radius and a long radius, such as sizes one through twenty inches. A tee and/or cross tee can be provided in sizes one through twenty inches. A forty-five degree lateral can be provided in sizes of one inch through twenty-inches. A concentric and eccentric reducer can be provided. A Y fitting can be provided in sizes one through twenty inches.

In operation, the apparatus 1 can be installed in a piping system with abrasive fluids. The life of apparatus 1, in accordance with an embodiment of the present invention is greater than the life of prior art materials.

The ceramic inner cylinder 20 of apparatus 1 can withstand high abrasion & corrosion caused by solids, liquids or slurry passing through the inner chamber 20c of the inner cylinder 20 shown in cross sectional diagram in FIG. 5. The high wear resistant properties of fittings, such as the apparatus 1 in accordance with an embodiment of the present invention, cause them to outlast any regular fiber glass or carbon steel pipe and fitting.

The apparatus 1 may have a diameter of D1 shown in FIG. 3 which may be, for example, in the range of one to twenty inches. The flanges or sections 2 and 102 which may be ANSI (American Standards National Institute) flanges.

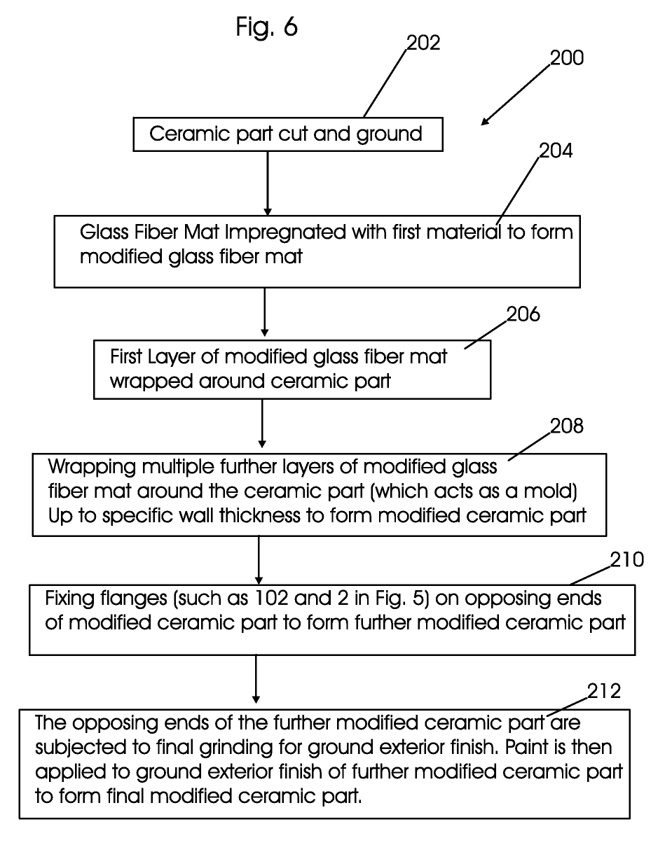

FIG. 6 shows a flow chart 200 of a method in accordance with an embodiment of the present invention. At step 202 a ceramic part is cut and ground. The ceramic part may be formed by diamond cutting and grinding a standard length ceramic tube, to form a ceramic tube, such as inner ceramic tube 20 shown in FIG. 5. The inner cylinder or ceramic tube 20 may also be, or may be replaced by a cone or a bend or elbow shaped tube. The ceramic part may be made of 90% alumina, silicon carbine, or reaction bonded silicon carbide.

At step 204, a glass fiber mat may be impregnated with a first material to form a modified glass fiber mat. The first material may be vinyl ester resin. At step 206, a first single layer of the modified glass fiber mat may be wrapped around the ceramic part, which in this case is inner cylinder or ceramic tube 20, shown in FIG. 5.

At step 208, further multiple layers of modified glass fiber mat may be wrapped around the ceramic part or inner tube 20 (inner tube 20 can also be called a “mold” since it is used as a mold to form the fiber glass parts 22, 24, 26) up to a specific wall thickness which depends on the size of the ceramic inner tube 20 to form a modified part including a ceramic inner tube 20, and an outer fiber glass covering or layer (2, 22, 24, 26, and 102) as shown in FIG. 5. The wall thickness of the modified glass fiber may be 1/21 of an inch or 1 inch or some other size depending on the size of the ceramic inner cylinder or tube 20.

At step 210, flanges, such as flanges 2 and 102 shown in FIG. 5, may be fixed on opposing ends of the modified ceramic part to form a further modified part which includes inner ceramic tube 20, fiber glass flanges 2, fiber glass coverings 2, 22, 24, and 26, and fiber glass flange 102. The outer cylinder 18 shown in FIG. 5, may have a diameter D2, which may be between one inch and twenty inches. The Each of the flanges 2 and 102 may have an outer diameter D1, shown in FIG. 3, which may be in the range of six inches to twenty-seven and one half inches. The flanges 2 and 102 may be ANSI flanges.

At step 212, opposing ends, i.e. a first end near opening 20a, and a second end near opening 20b, of the further modified part, are subjected to final grinding for a ground exterior finish. Finally, paint, such as a blue coat of paint, is typically applied to ground exterior finish of further modified part to form final modified part or apparatus 1. The blue paint is used merely for identification purposes.

Although in the apparatus 1, the ceramic inner cylinder 20 is shown as a straight tube, an apparatus can be constructed in accordance with the present invention, as a different type of fitting or piping, wherein the inner cylinder 20 would be, or would be replaced by a reducer or an elbow, for example.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a solid monolithic hollow ceramic inner liner; and
a fiber glass outer covering which has been wrapped around the solid monolithic hollow ceramic inner liner.

2. The apparatus of claim 1 wherein
the solid monolithic hollow ceramic inner liner is an inner tube.

3. The apparatus of claim 1 wherein
the solid monolithic hollow ceramic inner liner is a reducing cone.

4. The apparatus of claim 1 wherein
the solid monolithic hollow ceramic inner liner is an elbow.

5. The apparatus of claim 1 wherein
the solid monolithic hollow ceramic inner liner is a cylinder.

6. The apparatus of claim 1 wherein
the solid monolithic hollow ceramic inner liner is made of alumina ceramic.

7. The apparatus of claim 1 wherein
the solid monolithic hollow ceramic inner liner is made of silicon carbide.

8. The apparatus of claim 1 wherein
the solid monolithic hollow ceramic inner liner is made of reaction bonded silicon carbide.

9. The apparatus of claim 1 wherein
the fiber glass outer covering is a made of a vinyl ester.

10. The apparatus of claim 1 wherein
the fiber glass outer covering is a made of a glass fiber mat.

11. A method comprising:
forming a solid monolithic hollow ceramic inner liner; and
wrapping a fiber glass outer covering around the hollow ceramic inner liner.

12. The method of claim 11 wherein
a hand lay-up process is used to wrap the fiber glass outer covering.

13. The method of claim 11 further comprising
passing a liquid through the solid monolithic hollow ceramic inner liner.

14. The method of claim 13 wherein
the liquid is a slurry.

15. The method of claim 11 wherein
the solid monolithic hollow ceramic inner liner is an inner tube.

16. The method of claim 11 wherein
the solid monolithic hollow ceramic inner liner is a reducing cone.

17. The method of claim 11 wherein
the solid monolithic hollow ceramic inner liner is an elbow.

18. The method of claim 11 wherein
the solid monolithic hollow ceramic inner liner is a cylinder.

19. The method of claim 11 wherein
the solid monolithic hollow ceramic inner liner is made of alumina ceramic.

20. The method of claim 11 wherein
the solid monolithic hollow ceramic inner liner is made of silicon carbide.

21. The method of claim 11 wherein
the solid monolithic hollow ceramic inner liner is made of reaction bonded silicon carbide.
